(19) United States
(12) Patent Application Publication
(10) Pub. No.: US 2010/0015992 A1
(43) Pub. Date: Jan. 21, 2010

(54) METHOD AND APPARATUS FOR AUTOMATIC PHYSICAL CONFIGURATION OF MOBILE COMMUNICATION DEVICES

(75) Inventor: Ivan Nelson Wakefield, Cary, NC (US)

Correspondence Address: SNYDER, CLARK, LESCH & CHUNG, LLP, 754 ELDEN STREET, SUITE 202, HERNDON, VA, 20170, US

(73) Assignee: Sony Ericsson Mobile Communications AB, Lund (SE)

(21) Appl. No.: 12/173,375

(22) Filed: Jul. 15, 2008

(51) Int. Cl. H04Q 7/20; H04M 1/02

(52) U.S. Cl. 455/456.1; 455/556.1

(57) ABSTRACT

A triggering event relating to a function of the mobile communication device is detected. Based on detection, the physical configuration of the mobile communication device is automatically adjusted. A database associating triggering events with physical configurations, in accordance with a predefined policy, may be retrieved. The detected triggering event may be correlated to a particular physical configuration within the database to implement automatic adjustment of the physical configuration of the mobile communication device.

### BACKGROUND

The present disclosure relates to mobile communication devices, more particularly to automatic physical configuration of mobile communication devices.

Mobile communication devices, such as cellular phones, laptop computers, pagers, personal communication system (PCS) receivers, personal digital assistants (PDA), and the like, provide advantages of ubiquitous communication without geographic or time constraints, as well as the added security of being able to contact help in the event of an emergency. Advances in technology and services have also given rise to a host of “additional” features beyond that of mere voice communications including, for example, audio-video capturing, data manipulation, electronic mailing, interactive gaming, multimedia playback, short or multimedia messaging, web browsing, etc. Other enhancements, such as location-awareness features, e.g., satellite positioning system (SPS) tracking, enable users to monitor their location and receive, for instance, navigational directions.

Accordingly, mobile telephone usage has expanded to include so many aspects of everyday life that it has become more than a luxury. This luxury extends beyond the conveniences of mere “wireless” operation, but also reaches towards “hands-free” operation as well. For instance, users may now communicate through wired or wireless headsets that enable users to speak with others without having to actually hold their mobile communication devices to their heads. Unfortunately, mobile communication device users must still physically manipulate their devices. Depending on the particular use of (or service being accessed by) the mobile communication device, there exists a number of different physical configurations. In certain environments, it can also be prudent for users to modify the physical configurations of their mobile communication devices, such as in cold, dark, hot, noisy, rainy, etc., environments, as well as in situational environments, e.g., while at home or work, attending a reception, eating dinner, etc. As such, it can be particularly cumbersome and inconvenient for users to have to consistently manipulate the physical components of their mobile communication devices.

Accordingly, a need exists for automatic physical configuration of mobile communication devices. A particular need exists for automatic physical configuration of mobile communications devices based on triggering events.

### DISCLOSURE

The above described needs are fulfilled, at least in part, by detecting a triggering event relating to a function of a mobile communication device, and based on detection, automatically modifying a physical configuration of the mobile communication device. A database associating triggering events with physical configurations, in accordance with a predefined policy, may be retrieved. The detected triggering event may be correlated to a particular physical configuration within the database to implement automatic adjustment of the physical configuration of the mobile communication device.

Triggering events may relate to initiating, receiving, or terminating a communication session, e.g., voice call, short messaging service (SMS) message, or multimedia messaging service (MMS) message. In certain instances, triggering events may correspond to sensed ambient conditions, e.g., lighting conditions, moisture conditions, and/or temperature conditions. Still further, triggering events may be associated with spatial positioning of the mobile communication device. Further, triggering events may be scheduled for specified times in accordance with scheduling information, e.g., date and/or time parameters, stored in the database.

The mobile communication device may be configured with built-in capabilities to facilitate detection of various triggering events. For instance, a processor (or event detection module) may be provided for detecting triggering events relating to a function of the mobile communication device. In certain instances, detected triggering events may be correlated to a particular physical configuration within the database. A communication interface may be provided for detecting initiation, reception, and termination of various communication sessions. One or more sensors may be included for sensing ambient conditions. A location module may be provided for resolving spatial positioning of the mobile communication device. Further, storage devices may be included for storing predefined policies associating one or more triggering events with one or more physical configurations, as well as scheduling these associations.

Automatic modification of a physical configuration of the mobile communication device may be carried out via one or more actuators, whether electrically powered (e.g., motorized devices, etc.), or operated through stored mechanical energy (e.g., spring and latch devices, etc.). Actuators may be utilized to automatically open a fold housing, slide housing, or swivel housing of the mobile communication device, or automatically extend an antenna, display, keypad, microphone, or speaker of the mobile communication device to a changed position.

Still other aspects, features, and advantages will be readily apparent to those skilled in this art from the following detailed description, wherein preferred embodiments of the disclosure are shown and described, simply by way of illustration of the best mode contemplated. The disclosure is capable of other and different embodiments, and its several details are capable of modifications in various obvious respects. Accordingly, the drawings and description are to be regarded as illustrative in nature, and not as restrictive.

### BRIEF DESCRIPTION OF THE DRAWINGS

The present disclosure is illustrated by way of example, and not by way of limitation, in the figures of the accompanying drawing and in which like reference numerals refer to similar elements and in which:

FIG. 1 is a block diagram of a mobile communication device, according to an exemplary embodiment; and

FIGS. 2 and 3 are flowcharts of processes for operating the mobile communication device of FIG. 1, according to exemplary embodiments.

### DETAILED DESCRIPTION

An apparatus, method, and software for providing automatic physical configuration of a mobile communication device are disclosed. In the following description, for the purposes of explanation, numerous specific details are set forth in order to provide a thorough understanding of exemplary embodiments. It is apparent, however, to one skilled in the art that exemplary embodiments may be practiced without these specific details or with an equivalent arrangement. In other instances, well-known structures and devices are shown in block diagram form in order to avoid unnecessarily obscuring exemplary embodiments.

Although exemplary embodiments are described with respect to automatically modifying a physical configuration of a mobile communication device, it is recognized by one skilled in the art that exemplary embodiments have applicability to automatically modifying other configurations of a mobile communication device.

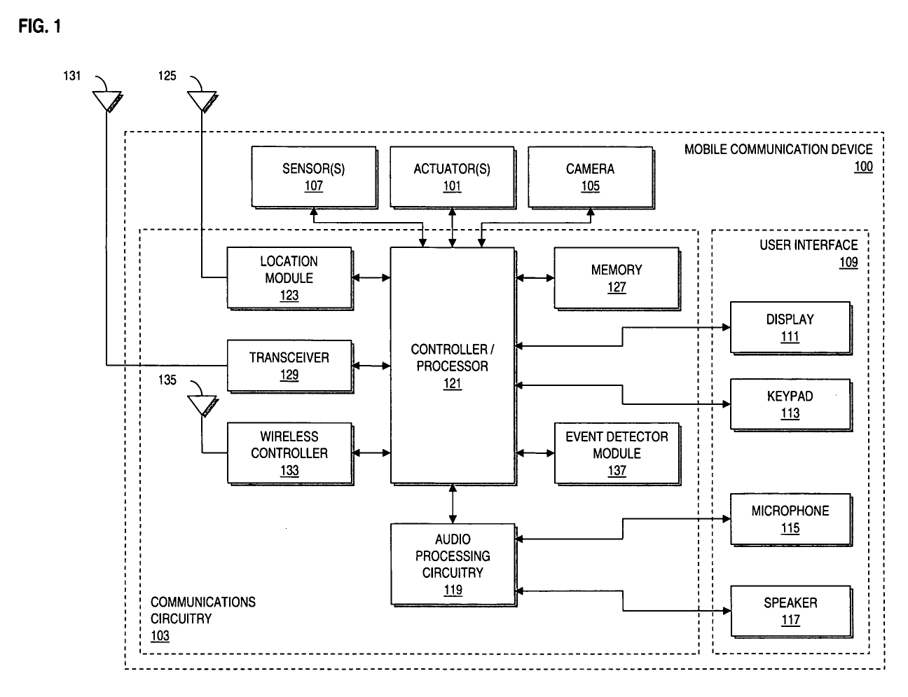

FIG. 1 is a block diagram of a mobile communication device, according to an exemplary embodiment. Mobile communication device 100 includes an automatic physical configuration function that is configured to automatically modify a physical configuration of mobile communication device 100 based on detection of one or more triggering events, such as initiation, reception, or termination of a communication session, sensation of an ambient condition, or resolution of spatial positioning of mobile communication device 100. It is contemplated that the automatic physical configuration function can be embodied as application software or executable code that resides in and is executed by mobile communication device 100.

According to one embodiment, mobile communication device 100 is a mobile phone, which may be provided in any suitable housing (or casing), such as a fold (or clamshell) housing, slide housing, or swivel housing. In this example, mobile communication device 100 includes one or more actuators 101, communications circuitry 103, camera 105, one or more sensors 107, and user interface 109. While specific reference will be made thereto, it is contemplated that mobile communication device 100 may embody many forms and include multiple and/or alternative components.

User interface 109 includes display 111, keypad 113, microphone 115, and speaker 117. Display 111 provides a graphical interface that permits a user of mobile communication device 100 to view call status, configurable features, contact information, dialed digits, directory addresses, menu options, operating states, time, and other service information, such as physical configuration policies associating triggering events to physical configurations for automatically modifying a physical configuration of mobile communication device 100, scheduling information (e.g., date and time parameters) for scheduling these associations, etc.. The graphical interface may include icons and menus, as well as other text, soft controls, symbols, and widgets. In this manner, display 111 enables users to perceive and interact with the various features of mobile communication device 100.

Keypad 113 may be a conventional input mechanism. That is, keypad 113 may provide for a variety of user input operations. For example, keypad 113 may include alphanumeric keys for permitting entry of alphanumeric information, such as contact information, directory addresses, phone lists, notes, etc. In addition, keypad 113 may represent other input controls, such as a joystick, button controls, dials, etc. Various portions of keypad 113 may be utilized for different functions of mobile communication device 100, such as for conducting voice communications, SMS messaging, MMS messaging, etc. Keypad 113 may include a “send” key for initiating or answering received communication sessions, and an “end” key for ending or terminating communication sessions. Special function keys may also include menu navigation keys, for example, for navigating through one or more menus presented via display 111, to select different mobile communication device functions, profiles, settings, etc. Other keys associated with mobile communication device 100 may include a volume key, an audio mute key, an on/off power key, a web browser launch key, a camera key, etc. Keys or key-like functionality may also be embodied through a touch screen and associated soft controls presented via display 111.

Microphone 115 converts spoken utterances of a user into electronic audio signals, while speaker 117 converts audio signals into audible sounds. Microphone 115 and speaker 117 may operate as parts of a voice (or speech) recognition system. Thus, a user, via user interface 109, can construct user profiles, enter commands, generate user-defined policies, initialize applications, input information (e.g., physical configurations, scheduling information, triggering events, etc.), and select options from various menu systems of mobile communication device 100.

Communications circuitry 103 enables mobile communication device 100 to initiate, receive, process, and terminate various forms of communications, such as voice communications (e.g., phone calls), SMS messages (e.g., text and picture messages), and MMS messages. In other instances, communications circuitry 103 enables mobile communication device 100 to transmit, receive, and process data, such as endtones, image files, video files, audio files, ringbacks, ringtones, streaming audio, streaming video, etc. As such, communications circuitry 103 includes audio processing circuitry 119, controller (or processor) 121, location module 123 coupled to antenna 125, memory 127, transceiver 129 coupled to antenna 131, and wireless controller 133 (e.g., a short range transceiver) coupled to antenna 135.

It is noted that a specific design and implementation of communications circuitry 103 can be dependent upon one or more communication networks for which mobile communication device 100 is intended to operate. For example, mobile communication device 100 may be configured for operation within any suitable wireless network utilizing, for instance, an electromagnetic (e.g., radio frequency, optical, and infrared) and/or acoustic transfer medium. In various embodiments, mobile communication device 100 (i.e., communications circuitry 103) may be configured for operation within any of a variety of data and/or voice networks, such as advanced mobile phone service (AMPS) networks, code division multiple access (CDMA) networks, general packet radio service (GPRS) networks, global system for mobile communications (GSM) networks, internet protocol multimedia subsystem (IMT) networks, personal communications service (PCS) networks, time division multiple access (TDMA) networks, universal mobile telecommunications system (UTMS) networks, or a combination thereof. Other types of data and voice networks (both separate and integrated) are also contemplated, such as microwave access (MiMAX) networks, wireless fidelity (WiFi) networks, satellite networks, and the like.

Location determination capabilities can be implemented on mobile communication device 100 via location module 123. In addition to manual entry of location information via, for example, user interface 109 (e.g., keypad 113), spatial position (or location) determinations may be performed when a positioning feature or service is made available to mobile communication device 100 through, for example, location module 123. Location module 123 may be any suitable position determining device, such as a satellite positioning system (SPS) receiver (e.g., a global positioning system (GPS) receiver, Galileo satellite system (GSS) receiver, etc.), hybrid assisted SPS device (e.g., GPS and advanced forward link trilateration (A-FLT) receiver, etc.), or radio network dependent receiver (e.g., enhanced cellular identification (CELL-ID) receiver, etc.), or other like device. In this manner, location module 123 may determine spatial positioning of mobile communication device 100 via one or more signals received by antenna 125 and processed by, for instance, location module 123 and/or controller 121.

Wireless controller 133 acts as a local wireless interface, such as an infrared transceiver and/or a radio frequency adaptor (e.g., Bluetooth adapter), for establishing communication with an accessory, hands-free adapter, another mobile communication device, computer, or other suitable device or network.

Processing communication sessions may include storing and retrieving data from memory 127, executing applications to allow user interaction with data, displaying video and/or image content associated with data, broadcasting audio sounds associated with data, and the like. Accordingly, memory 127 may represent a hierarchy of memory, which may include both random access memory (RAM) and read-only memory (ROM). Computer program instructions, such as “automatic physical configuration” application instructions, and corresponding data for operation, can be stored in non-volatile memory, such as erasable programmable read-only memory (EPROM), electrically erasable programmable read-only memory (EEPROM), and/or flash memory; however, may be stored in other types or forms of storage. Memory 127 may be implemented as one or more discrete devices, stacked devices, or integrated with controller 121. Memory 127 may store program information, such as one or more user profiles, one or more user defined policies, one or more triggering events, one or more physical configurations, scheduling information, etc. In addition, system software, specific device applications, program instructions, program information, or parts thereof, may be temporarily loaded to memory 127, such as to a volatile storage device, e.g., RAM. Communication signals received by mobile communication device 100 may also be stored to memory 127, such as to a volatile storage device.

Controller 121 controls operation of mobile communication device 100 according to programs and/or data stored to memory 127. Control functions may be implemented in a single controller (or processor) or via multiple controllers (or processors). Suitable controllers may include, for example, both general purpose and special purpose controllers, as well as digital signal processors, local oscillators, microprocessors, and the like. Controller 121 may also be implemented as a field programmable gate array (FPGA) controller, reduced instruction set computer (RISC) processor, etc. Controller 121 may interface with audio processing circuitry 119, which provides basic analog output signals to speaker 117 and receives analog audio inputs from microphone 115.

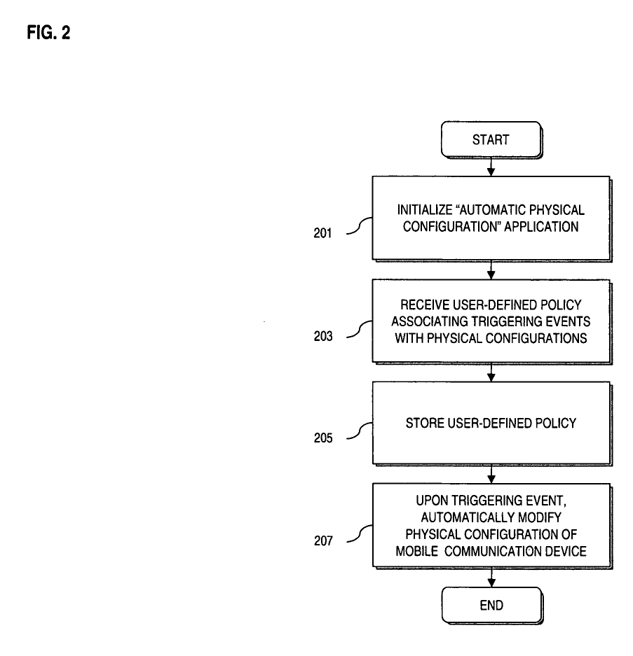

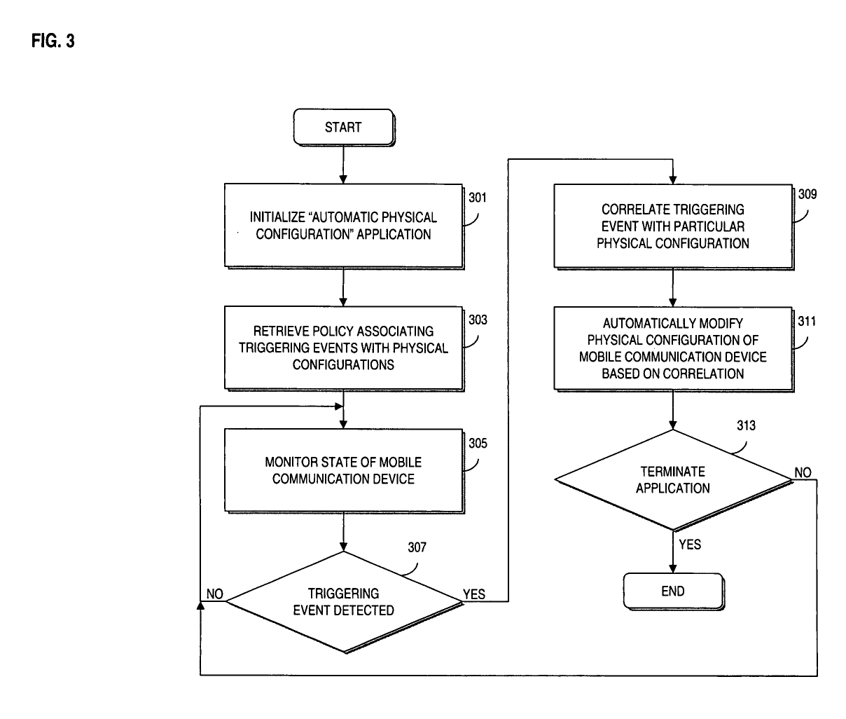

Controller 121, in addition to orchestrating various operating system functions, also enables execution of software applications, such as an “automatic physical configuration” application stored to memory 127. A predetermined set of software applications that control basic device operations, such as voice and data communications, may be installed on mobile communication device 100 during manufacture. The “automatic physical configuration” application may also be installed on mobile communication device 100 during manufacture, to implement exemplary embodiments described herein, such as the processes of FIGS. 2 and 3. It is contemplated that additional software modules may also be provided, such as a location determination application for resolving spatial positioning of mobile communication device 100 based on one or more signals received at antenna 125 and processed by location module 123 and/or controller 121. Other software modules may be provided for sensing ambient conditions, or detecting triggering events (e.g., event detector module 137).

Mobile communication device 100 can also include camera 105 for capturing digital images and/or movies. Image and video files corresponding to the captured pictures and/or movies may be stored to memory 127.

In exemplary embodiments, the various components of a housing (or casing) of mobile communication device 100 may be physically configured via one or more actuators 101. Other suitable physically configurable components of mobile communication device 100 can include the components of user interface 109 or camera 105. As such, actuators 101 can be configured to induce two-dimensional displacement or rotation, as well as three-dimensional displacement or rotation. In certain instances, actuators 101 may convert stored electrical or mechanical energy into mechanical kinetic energy for automatically modifying a physical configuration of mobile communication device 100. Actuators 101 can include one or more electrically powered mechanisms (e.g., electroactive polymers, microelectromechanical system (MEMS) devices, motors, nanoelectromechanical system (NEMS) devices, piezoelectric materials, telescopic members, etc.), one or more stored mechanical energy mechanisms (e.g., various spring and latch assemblies, etc.), or combinations thereof. Thus, actuators 101 may be utilized to physical configure (e.g., mobilize) mobile communication device housing (or casing) openings (e.g., flip opening housings, slide opening housings, swivel opening housings, etc.), extending one or more antennas (e.g., antennas 125, 131;,or 135), one or more displays (e.g., display 111), one or more keypads (e.g., keypad 113), one or more microphones (e.g., microphone 115), one or more speakers (e.g., speaker 117), one or more cameras (e.g., camera 105), or combinations thereof. In other instances, actuators 101 may be provided for physically manipulating subcomponents of one or more of the aforementioned components, e.g., a flash (not shown) of camera 105, etc.

Accordingly, controller 121 also initiates and controls the operation of actuators 101, i.e., automatic modification of a physical configuration of mobile communication device 100. As such, automatic modifications may be based on one or more triggering events detected by controller 121 (or other suitable component of mobile communication device 101, such as event detector module 137). One such triggering event may correspond to sensation of one or more ambient conditions, such as an audio condition, lighting condition, moisture condition, temperature condition, proximity condition, or combination thereof. In this manner, mobile communication device 100 can include one or more sensors 107 for sensing one or more of these ambient conditions. Sensors 107 may include various transducers, such as electroacoustic transducers (e.g., microphone, piezoelectric crystal, etc.), electromagnetic transducers (e.g., photodetector, photoresistor, hall effect sensor, etc.) electromechanical transducers (e.g., accelerometer, air flow sensor, load cell, strain gauge, etc.), electrostatic transducers (e.g., electrometer, etc.), thermoelectric transducers (e.g., resistance temperature detector, thermocouple, thermistor, etc.), or radioacoustic transducers (e.g., radio frequency receiver, etc.), as well as combinations thereof.

Other triggering events may correspond to initiation, reception, or termination of a communication session. Initiation and termination of various communication sessions may be determined based on user input to user interface 109 (e.g., user interaction with the aforementioned “send” or “end” keys, voice commands input via microphone 115, etc.). Meanwhile, reception of various communication sessions may be determined via one or more signals received at communications circuitry 103 (e.g., received by antennas 131 and/or 135 and processed by transceiver 129, wireless controller 133, event detector module 137, and/or controller 121). These communication sessions may relate to voice communications, SMS messages, MMS messages, or other communication feature of mobile communication device 101, such as electronic mailing, multimedia playback, web browsing, etc. Further, triggering events may relate to a location of mobile communication device 100 (e.g., resolution of spatial positioning of mobile communication device 100 via one or more signals received by antenna 125 and processed by location module 123 and/or controller 121). In certain instances, automatic physical configuration of mobile communication device 100 via actuators 101 is induced based on detection of other inputs to user interface 109, such as initializing a camera function, multimedia playback function, etc.

While exemplary embodiments of mobile communication device 100 have been described with respect to a two-way radio frequency communication device having voice and data communication capabilities, embodiments of mobile device 100 are not so limited. For instance, mobile communication device 100 may additionally (or alternatively) correspond to any suitable wireless two-way communicator. For example, mobile communication device 100 can be a cellular phone, two-way trunked radio, combination cellular phone and personal digital assistant (PDA), smart phone, cordless phone, satellite phone, or any other suitable mobile communication device with voice and/or data communication capabilities, such as a mobile computing device.

FIG. 2 is a flowchart of a process for operating mobile communication device 100 of FIG. 1, according to an exemplary embodiment. At step 201, mobile communication device 100 executes an “automatic physical configuration” application in response to user initialization. That is, controller 121 implements instructions stored to memory 127 in response to user interaction with user interface 109, e.g., keypad 113. Operation of controller 121 provides a graphical interface to the user via display 111. The graphical interface may include one or more input fields, menus, options, selections, etc., that enables the user to input profile information to mobile communication device 100. Thus, per step 203, mobile communication device 100 receives information for constructing a user-defined policy for automatic physical configuration of mobile communication device 100 based on detection of one or more triggering events.

User profile information may include one or more contacts, methods of communication, directory addresses, scheduling information, locations, spatial positions, and/or ambient conditions, as well as any other suitably configurable parameter for inducing automatic modification of a physical configuration of mobile communication device 100. For example, predefined policies may be generated for associating triggering events with physical configurations. These associations may be further scheduled via defined date and timing requirements, spatial positioning requirements, etc. User profile information, including user-defined policies, may be input via user interface 109, e.g., interaction with keypad 113. A user may be provided with the capability to download user profile information or predefined policies to mobile communication device 100 via a wired (e.g., universal serial bus, etc.) or wireless (e.g., infrared, wireless local area network, etc.) connection. It is contemplated that the user profile information and/or the predefined policies can be synchronized with a central repository (not shown) of, for example, a network of a service provider, e.g., one or more of the aforementioned networks.

In step 205, the user-defined policy is stored as a database in memory 127. This information can be simultaneously (or later) uploaded and/or synchronized with a centralized repository. The “automatic physical configuration” application may then continue to be executed via controller 121 as a background application. Alternatively, mobile communication device 100 can be set by the user to be operated in accordance with a time schedule, location schedule, ambient condition schedule, or arbitrarily. At step 207, a triggering event (such as one or more of the aforementioned triggering events) invokes automatic modification of a physical configuration of mobile communication device 100 via actuator(s) 101.

FIG. 3 is a more detailed flowchart of a process for operating mobile communication device 100 in accordance with step 207. At step 301, the “automatic physical configuration” application is initialized by mobile communication device 100, i.e., controller 121. Initialization may be performed in response to a user “powering up” mobile communication device 100 or may be performed in response to user interaction with a menu option or selectable feature of a graphical interface provided via display 111. At step 303, controller 121 retrieves a database associating triggering events with physical configurations from, for example, memory 127. In exemplary embodiments, the database may have been pre-established by a manufacturer of mobile communication device 100, a service provider making mobile communication device 100 available to subscribers, or input by an owner or user of mobile communication device 100.

In any case, controller 121 (or event detector module 137) monitors a state of mobile communication device 100, per step 305. The state of mobile communication device 100 relates to one or more of the aforementioned triggering events. At step 307, controller 121 (or event detector module 137) determines whether a triggering event has been detected. If a triggering event is not detected, controller 121 continues to monitor the state(s) of mobile communication device 100. If a triggering event is detected, controller 121 correlates the detected triggering event with a particular physical configuration stored within the retrieved database, at step 309. Conflicts between policies may be resolved through a hierarchical prioritization by, for example, the owner or user of mobile communication device 100, the manufacturer of mobile communication device 100, or service provider of mobile communication device 100. It is noted that more than one triggering event may be detected and, thereby, accounted for by controller 121.

Thus, during step 311, controller 121 initializes and controls one or more actuators 101 to automatically modify a physical configuration of mobile communication device 100 based on correlation, i.e., step 309, and, ultimately, based on detection of the detected triggering event(s), i.e., step 305. It is contemplated that one or more automatic modifications to a physical configuration of mobile communication device 100 may be implemented. Modifications may be performed simultaneously or in tandem fashion. Accordingly, controller 121 determines whether or not to terminate the “automatic physical configuration” application, such as when mobile communication device 100 is “powered down,” per step 313. If the application is to terminate, the process ends, otherwise, the process reverts to step 305, i.e., controller 121 continues to monitor the state(s) of mobile communication device 100.

In this disclosure there are shown and described preferred embodiments and but a few examples of their versatility. It is to be understood that the disclosure is capable of use in various other combinations and environments and is capable of changes or modifications within the scope of the concepts as expressed herein.

What is claimed is:

1. A method comprising:
detecting a triggering event relating to a function of a mobile communication device; and
in response to detection of the event, automatically adjusting a physical configuration of the mobile communication device.

2. A method as recited in claim 1, wherein the step of adjusting comprises:
changing a position of a component of the device.

3. A method as recited in claim 1, wherein the step of adjusting comprises:
opening a housing of the device.

4. A method as recited in claim 1, wherein the triggering event comprises a communication session related occurrence.

5. A method as recited in claim 4, wherein the communication session related occurrence comprises a change in communication status.

6. A method as recited in claim 1, wherein the step of detecting comprises:
sensing an ambient condition.

7. A method as recited in claim 6, wherein the ambient condition relates to a state of climate proximate the device.

8. A method as recited in claim 1, wherein the triggering event comprises:
resolution of a spatial position of the mobile communication device.

9. A method as recited in claim 1, wherein the step of adjusting further comprises:
accessing a database in which triggering events are associated with respective physical configurations; and
correlating the detected triggering event to physical configuration associated therewith in the database.

10. A method as recited in claim 9, wherein the database comprises scheduling information upon which associations between the triggering events and the physical configurations are dependent.

11. A mobile communication device, comprising:
an event detector module configured to detect a triggering event relating to a function of the mobile communication device; and
an actuator configured to automatically adjust a physical configuration of the mobile communication device in response to detection of the triggering event.

12. A mobile communication device as recited in claim 11, wherein automatic adjustment of the physical configuration comprises opening a housing of the device.

13. A mobile communication device as recited in claim 11, wherein automatic adjustment of the physical configuration comprises changing a position of a component of the device.

14. A mobile communication device as recited in claim 11, further comprising:
a communication interface
wherein the triggering event comprises a predefined operation of the communication interface.

15. A mobile communication device as recited in claim 14, wherein the predefined operation is related to a communication session.

16. A mobile communication device as recited in claim 11, further comprising:
an ambient condition sensor;
wherein adjustment of the physical configuration is responsive to a sensed ambient condition.

17. A mobile communication device as recited in claim 16, wherein the ambient condition relates to a state of climate proximate the device.

18. A mobile communication device as recited in claim 11, further comprising:
a location module configured to resolve spatial positioning of the mobile communication device;
wherein adjustment of the physical configuration is responsive to resolution of spatial positioning by the location module.

19. A mobile communication device as recited in claim 11, further comprising:
a memory comprising a database in which triggering events are associated with respective physical configurations;
wherein adjustment of a physical configuration of the mobile communication device corresponds to the triggering event associated therewith in the database.

20. A mobile communication device as recited in claim 19, wherein the database comprises scheduling information upon which associations between the triggering events and the physical configurations are dependent.
